(19) United States
(12) Patent Application Publication
(10) Pub. No.: US 2015/0153118 A1
(43) Pub. Date: Jun. 4, 2015

(54) MANUFACTURING METHOD OF HEAT SINKS

(71) Applicant: Juan Miguel Cordero Gómez Del Campo, Tlapan (MX)

(72) Inventor: Juan Miguel Cordero Gómez Del Campo, Tlapan (MX)

(21) Appl. No.: 14/558,611

(22) Filed: Dec. 2, 2014

(30) Foreign Application Priority Data
Dec. 2, 2013 (MX) MX/A/2013/014130

(51) Int. Cl. F28F 21/08; F28F 13/00; B23P 15/26

(52) U.S. Cl. CPC F28F 21/084; B23P 15/26; F28F 13/00

(57) ABSTRACT

The invention relates to a method for manufacturing heat sinks and the heat sinks derived from this kind of methodology; which are not. extruded or require cast machines so various types of heat sinks can be designed for different dissipating temperatures and suit them to the cooling requirements.

### TECHNICAL FIELD OF THE INVENTION

The present invention relates to a method for manufacturing heat sinks and the heat sinks derived from this kind of methodology; wherein the heat sinks are those used to cool electronic components. Particularly, the invention relates to the manufacture of heat sinks which are not extruded or require cast machines so various types of heat sinks can be designed for different dissipating temperatures and suit them to the cooling requirements.

### BACKGROUNDS OF THE INVENTION

The heat sinks have been widely used in the heat dissipation industry, for example, for semiconductors; today, the heat sinks are manufactured in single block pieces, that is, the aluminum is cast and extruded so as to form the heat sink, this type of manufacturing is complex as it requires, firstly, to have the parameters of the element to be cooled and the information of the required dissipation, for example, there has to have the information about the maximum temperature in the “Junction”, the housing temperature, the heat sink temperature, room temperature, the power dissipated in the lamp, the thermal resistance between the junction and the housing, thermal resistance between the housing and the heat sink, thermal resistance between the heat sink and the air, thermal resistance between the junction and the air; once the information of the temperature to be dissipated being obtained, a heat sink is designed so as to achieve the purpose, for such ends, a mold is generated, the aluminum is cast and lastly extruded so as to create a single piece heat sink. While the above may result in suitable features heat sinks, the above bears the disadvantage that a higher or lower size heat sink may not be achievable by the designer or held by the final user, and thus there is a reliance on the heat sink manufacturer, this having the disadvantage that a heat sink must be designed and manufactured for each application, for example, for each lamp, so if the features of the lamp change (for example, the power to be dissipated), then a new heat sink must be designed with the involved costs.

Although the market offers endless heat sinks, a problem with the conventional heat sinks is that they are only manufactured for a single type of temperature to be dissipated and/or only in predetermined environmental conditions, this means that there are no heat sinks that may be suited so as to increase the heat transfer towards the environment, while the prior art heat sinks do not suffice when the temperature rises (warm zones) and the heat sinks are not able to transfer the semiconductors heat to the environment, i.e., in order to use these kind of heat sinks multiple calculations must be done, resulting in multiple heat sinks which have to be designed and manufactured for each application.

Those skilled in the art know that there is the need of heat sinks for electronic components such as solid state lamps, likewise, there is the need of quickly and easily manufacturing heat sinks which need not to be cast and/or extruded and that may be directly manufactured by the user in need of a heat sink and which consider the different dissipation features. There is also the need for heat sinks which are manufactured using the elements found in the market with no further need of aluminum casting.

The present invention aims to provide a heat sink and manufacturing method thereof which overcomes or substantially alleviates the issues related with the above cited cast and/or extruded heat sinks

### OBJECTS OF THE INVENTION

According to the present invention, the main object thereof is to provide a method for manufacturing heat sinks comprising aluminum elements.

A second object of the present invention is to provide a method of making heat sinks wherein the number of discs is added or reduced for making sinks comprising a greater or lesser heat dissipation. Advantageously, this arrangement results in a greater number of sinks without changing the basic shape.

A third object of the present invention is to provide a method of making heat sinks wherein the diameter of the discs is changed so as to include a greater thermal dissipation; advantageously, this kind of arrangement helps to obtain sinks with no greater height.

A fourth object of the present invention is to provide a method of making heat sinks wherein the diameter of the disc may be reduced so as to obtain sinks with lower heat dissipation.

A fifth object of the present is to provide a method of making heat sinks wherein endless arrangements are manufactured by changing the thickness of the aluminum dividers.

A sixth object of the invention is to provide a method of making heat sinks wherein the pieces are provided with a chamfer.

A seventh object of the invention is to provide a method of making heat sinks wherein the sink discs comprise a flat square area and a number of fins extending from the edges of the square area.

In a preferred embodiment, the heat sink, once formed, comprises a substantially cylindrical shape, with no limitation regarding the shape of the discs, except as provided in the current Mexican regulations.

In another embodiment, the centring pieces comprise different thicknesses so as to support a greater number of plates with no need of making extra molds.

### BRIEF DESCRIPTION OF THE FIGURES

The preferred embodiments of the present invention will be described as follows, by way of example only and with reference to the attached drawings, in which:

FIG. 1 is an isometric view of the preferred embodiment of the present invention.

FIG. 2 shows a side view of the heat sink of the present invention.

FIG. 3 shows a front view of the primary dissipation disc of the present invention.

FIG. 4 is a block diagram of the heat sink formation of the present invention.

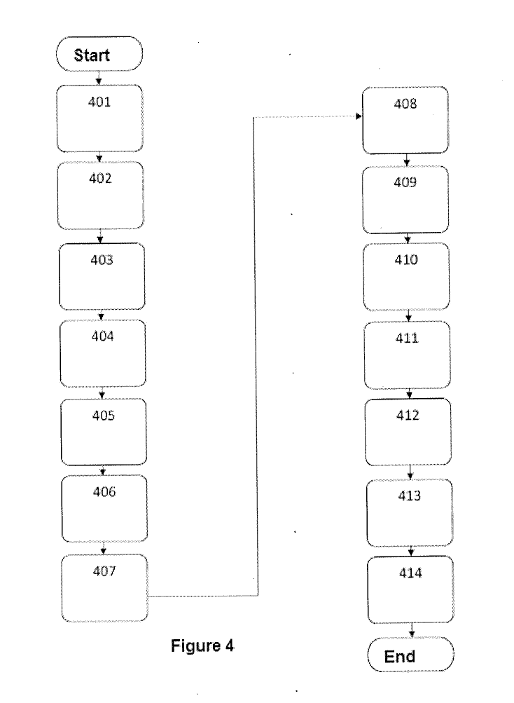

FIG. 5 shows a front view of the heat sink of the present invention.

### DETAILED DESCRIPTION OF THE INVENTION

As used herein, the heat sink can be used in LED-type lamps which require a high heat dissipation due to the operation of the lamps itself, likewise, the lamps must include at least one flat surface which conforms to the flat surface of the heat sink as illustrated; notwithstanding the above, the sinks herein described may comprise a myriad of uses which only requirement is to comprise a flat face for contacting the element to be cooled for the heat transfer.

In the design of heat sinks field, there have a number of disadvantages with respect to the prior art, firstly, there is the fact that the current sinks are those comprised by one single piece, so there is no possibility of an in situ design of sinks depending on the needed amount of heat to be dissipated or on the dimensions of the enclosure which will enclose same.

The present invention comprises a finite number of pieces for making sinks; particularly, the procurement of molds and/or cast and/or extrusion machines is omitted, so an endless number of embodiments may be created by simply changing a few pieces with no need of redesigning the molds, so there is a significant time saving.

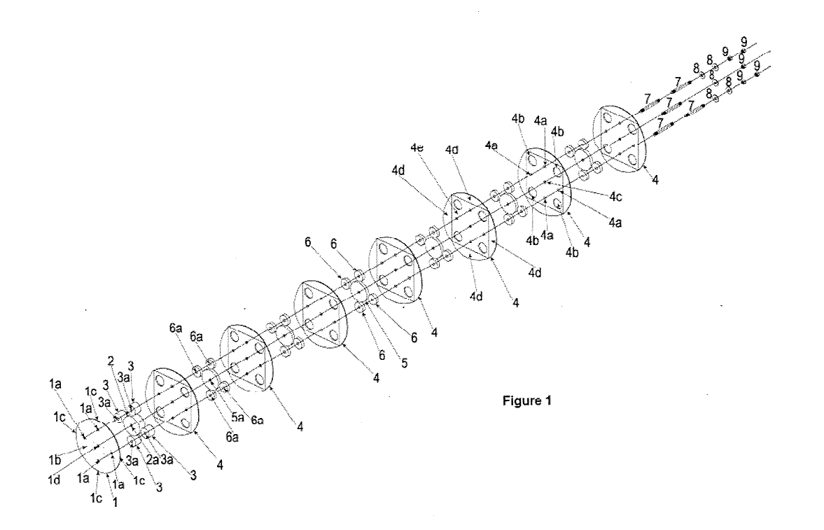

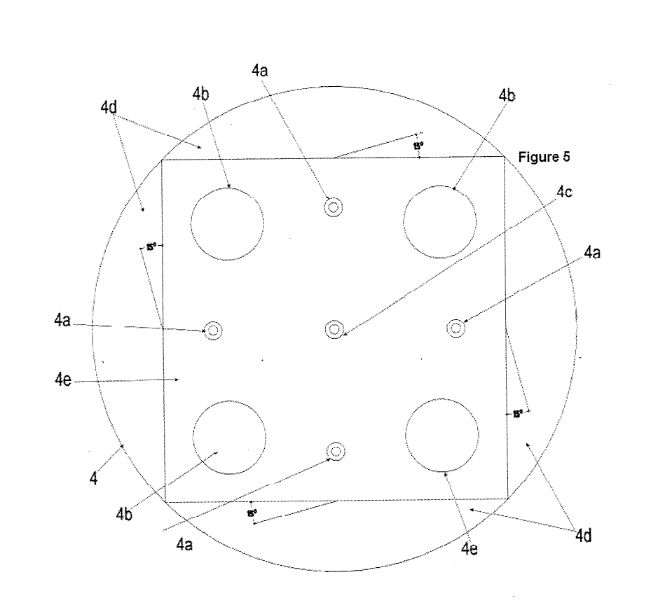

With respect to FIG. 1, there is an isometric and an assembly view of the preferred embodiment of the present invention which is illustrative but not restrictive of the method for manufacturing heat sinks. Firstly, FIGS. 1 and 5 show at least two discs (4), whereas the embodiment shows 7 discs (4), wherein the discs (4) are made of aluminum and comprise a substantially circular shape; the discs (4) comprise a flat square area (4e) and a series of fins (4d) extending from the edges of the square area (4c) at an approximately 15 degrees angle; this arrangement allows for a better heat transfer from the flat square area (4e) to the fins (4d); likewise, the discs (4) comprise four bores (4a) equidistantly located at the center of the disc and a central bore (4c), all in the square area (4e); each of the four bores (4a) and the central bore (4c) comprise an equal bore diameter; also, each of the four bores (4a) and the central bore (4c) are traversed by screws (7) so as to keep the discs (4) fixed with the side aluminum dividers (6), and the central aluminum dividers (5); additionally, each of the discs (4) comprise guide bores (4b) which comprise a diameter which is larger than each of the four bores (4a) and the central bore (4c) and are equidistantly aligned with each of the four bores (4a) thus forming a bores square when each of the discs is seen frontally, each of the discs being preferably located at the corners of the square area (4e); the guide bores (4b) are preferred for assembling the heat sink or in order for the air to be able of circulating in the discs (4), i.e., same are used for providing the discs (4) in such a way that the heat sinks may be automatically or manually assembled.

Additionally, FIG. 1 shows at least four side aluminum dividers and one central aluminum divider, the illustrated embodiment comprises six sets of four side aluminum dividers and one central aluminum divider; wherein the side aluminum dividers (6) and the central aluminum dividers (5) comprise a substantially cylindrical shape, said side aluminum dividers (6) and central aluminum dividers (5) comprising a chamfer in the rims of both sides of the circumference with the purpose of allowing for the evacuation of the excess dissipating grease, wherein each of the side aluminum dividers (6) and central aluminum dividers (5) comprise bores (5a) and (6a) respectively, said bores (5a) and (6a) being longitudinal along the formed cylinder and which are traversed by screws (7) and comprising a countersink in the bores so as to allow for the evacuation of the excess dissipating grease and for having a perfect discs (4) joint with the side aluminum dividers (6) and the central aluminum dividers (5). The heat sink body is formed by the joint of the discs (4) in its square area (4e) with the side aluminum dividers (6) and the central aluminum dividers (5) and which are traversed by the screws (7); likewise, the screws traverse the combination of a disc (4) with four side aluminum dividers (6) and one central aluminum divider (5) alternately combined so as to form the heat sink body.

FIG. 1 shows the closest end to the primary dissipation disc (1) wherein the screws (7) are attached to a central aluminum round (2) and side aluminum rounds (3a) by means of screw threads in said central aluminum round (2b) and side aluminum rounds (3a) and are tightened on the opposite end by means of washers and nuts, so the heat sink body remains solid and ready for receiving the primary dissipation disc (1).

Each set of four side aluminum dividers (6) and one central aluminum divider (5) are equally spaced between them where the side aluminum dividers (6) surround the central aluminum divider (5), wherein the side aluminum dividers (6) further comprise a diameter greater than the central aluminum divider (5), thus generating a better heat transfer between the discs.

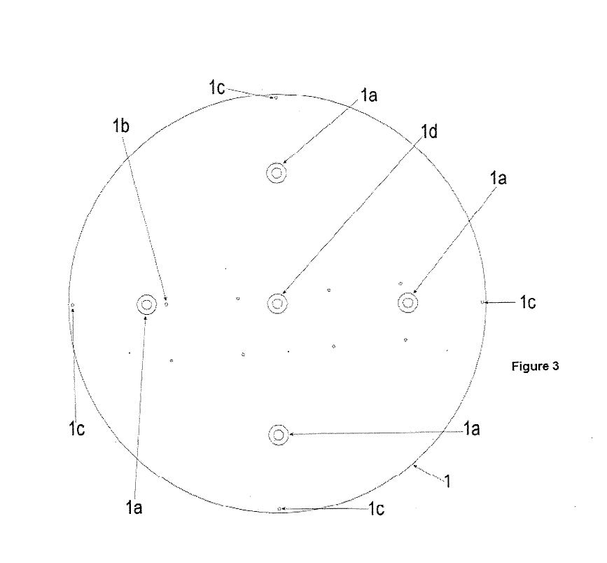

Also, FIGS. 1 and 3 show the primary dissipation disc (1) comprising four countersunk bores (1a) at the outer face which attach the components to be cooled wherein the countersink is at 45 degrees, whereas there is, additionally, a central countersunk bore (1d), said bores at the outer face so as to receive conical head screws (not shown in FIG. 1), likewise there are eight bores (1b) which are located between two of the countersunk bores (1a) which are useful for fixing the LED lamps, the eight bores (1b) comprising screw threads. The primary dissipation disc (1) is attached to the remainder of the sink (formed by at least two disks (4) with at least four side aluminum dividers (6) and at least one central aluminum divider (5), at least five screws (7) , at least five washers (8) and at least five nuts (9)) by means of a central aluminum round (2) and four side aluminum rounds (3), by means of conical head screws (not shown in FIG. 1), this ensuring a flat surface that contacts the element to be cooled. The central aluminum round (2) and the side aluminum rounds (3) comprise a substantially cylindrical shape, said central aluminum round (2) and side aluminum rounds (3) comprising a chamfer at both sides of the rim of the circumference in order to allow for the evacuation of the excess dissipating grease, wherein each of the central aluminum round (2) and the side aluminum rounds (3) comprise bores (2a) and (3a) which are longitudinal along the cylinder formed and which comprise screw threads at the ends so as to screw the screws (7) on one side and the conical head screws (not shown in FIG. 1) on the other, further comprising a countersink in the bores so as to allow for the evacuation of the excess dissipating grease and achieve a perfect joint of the proximal disc (4) and the primary dissipation disc (1) with the central aluminum round (2) and the side aluminum rounds (3). Furthermore, the primary dissipation disc (1) comprises a series of perimeter bores (1c) which can be suited so as to receive different features lighting elements.

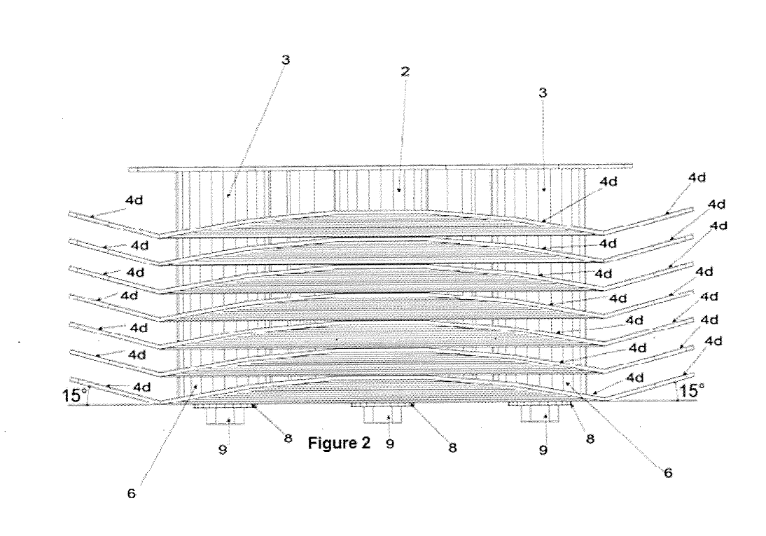

FIG. 2 shows a side view of the heat sink of the present invention wherein the main heat sink body comprises discs (4) showing fins (4d) which are at an angle of about 15 degrees, side aluminum dividers (6), washers (8) and nuts (9); the main heat sink body operatively attaches to a central aluminum round (2) and aluminum side rounds (3), said central aluminum round (2) and side aluminum rounds (3) are functionally attached to a primary dissipation disc (1). The main heat sink body is attached to the central aluminum round (2) and side aluminum rounds (3) by screws.

The method of making heat sinks as shown in FIGS. 1 to 3 is described as follows: First, the discs (4) are manufactured, firstly, the aluminum sheet, preferably gauge 14, is cut (401) in squared spans, it is die-cut (402) and bent so as to produce fins (4d); the discs are perforated (403) so as to create four bores (4a) and the central bore (4c), the bores being cross-shaped bores; the disc is perforated (404) so as to create guide bores (4b). Secondly, the primary dissipation disc (1) is formed; first, the aluminum sheet, preferably gauge 14, is cut (405) in squared spans, the sheet is die-cut (406) in predetermined size discs, the discs are perforated (407) so as to create four bores (1d) and a bore (1a), they are countersunk, perforated (408) with perimeter bores (1c) and eight bores (1b) off-centered from the center of the disc are made, which are aligned with a countersunk bore (1a) and a central countersunk bore (1d), wherein the eight bores (1b) are for fixing LED lamps; threads (409) are generated which are perforated with perimeter bores (1c) and the eight bores (1b). As a third step, the side aluminum dividers (6) and the central aluminum dividers (5) are formed, firstly, the aluminum solepiece is die-cut (410) to the desired diameter so as to obtain round dividers; the center of each divider is perforated (411), the bores (5a and 6a) are countersunk and a chamfer is made at the rims of both sides of the circumference. As a fourth step, central aluminum rounds (2) and side aluminum rounds (3) are generated, wherein the round is firstly cut (412) depending on the desired diameter, the pieces from one side are perforated (3a and 2a) to the preset depth and to the preset diameter, and the opposite side is perforated (413) to a preset depth and a preset diameter, wherein the diameter of the bores may vary, a countersink is made in both side bores and a chamfer is made at the rims of both sides of the circumference, a screw thread is made in each bore depending on the preset measure. As a fifth step, the screws (7), preferably aluminum screws, are generated (414) so as to attach the discs (4) wherein a pin is firstly cut to a specific measure of the required length and a screw thread is made at both sides. Finally, the heat sink is assembled, wherein the screws (7) are located and side aluminum dividers (6) and a central aluminum divider (5) are alternated with a disc (4) wherein dissipating grease is provided at each joint between the discs and the dividers until reaching the established amount of discs and thereafter tighten with nuts (9) and washers (8); the primary dissipation disc (1) is located at a central aluminum round (2) and side aluminum rounds (3) by means of conical head screws.

### PREFERRED EMBODIMENT

The preferred embodiment relates to a method of generating a certain measures heat sink and the heat sink itself, and it is shown in the following table:

### Process for the Leds Heat Sink

Gauge 14 Disc Size Cut with 10 Inches Diameter
Step 1—The 14 Gauge Aluminum Sheet is Cut in 10 11/16×48 Spans
Step 2—The Sheet is Die Cut in 10 Inch Discs
Step 3—The Discs are Die Cut so as to Make Five ⅜ Bores with 3½ Inch Separations Between them in 4 Bores Split at the Center of the Disc and 1 Bore at the Center of the Disc with Separations of 2½ Inches at the Center of the Four Bores
Step 4—The Disc is Die Cut so as to Make One ⅝ Bore at the Side of the Disc with a 11/16 Distance from the Rim of the Circumference to the Center of the Bore Aligned with 3 Above Described ⅜ Bores.
   Gauge 14 Disc Size Cut with 8 Inches Diameter
Step 1—The 14 Gauge Aluminum Sheet is Cut in 8 49/64 Spans
Step 2—The Sheet is Die Cut in 8 Inch Discs and is Bent so as to Create Fins
Step 3—Five Bores of 3/16 are Made in the Discs Split at the Center of the Disc with 3½ Inch in Four Bores Split at the Center of the Disc and 1 Bore at the Center of the Disc with Separations of 2½ Inches at the Center of the Above Four Bores
Step 4—Four Bores of ⅛ Diameter are Made at the Rim of the Disc with a 11/64 Separation at the Center of the Bore and with 5⅜ Separations at the Center of Each Bore.
Step 5—Eight Bores of ⅛ Diameter are Made Off-Centered of the Center of the Disc with the Following Measures 4⅛ from the Rim of the Disc to the Inside, Four of the 8 Bores are Aligned with a 1 19/32 Separation in the Two Bores at the Center and 1 7/16 Separation in the Bores at the Sides, these Bores Serve for Fixing the Leds
Step 6—Four Bores of ⅛ Diameter are Made at the Rim of the Disc with a 2½ Inches Separation at the Center of the Four Bores and with 2 63/64×5 5/32 Separations Between Each Other.
Step 7—A 5/32 Screw Thread is made in All the ⅛ Bores.
   ⅜×1½ Cut in Aluminum Dividers
Step 1—The ⅜×2 Inches Aluminum Solepiece is Die Cut so as to Obtain Round ⅜×½ Dividers
Step 2—A ⅜ Bore is Made at the Center of the Circle
Step 3—A Countersink is Made in Both Sides of the ⅜ Bore
Step 4—A Chamfer is Made at Both Sides of the Rim of the Circumference
   ⅜×3 Cut in Aluminum Dividers
Step 1—The ⅜×4 Inches Aluminum Solepiece is Die Cut so as to Obtain Round ⅜×3 Inches Dividers
Step 2—A ⅜ Bore is Made at the Center of the Circle
Step 3—A Countersink is Made in Both Sides fo the ⅜ Bore
Step 4—A Chamfer is Made at Both Sides of the Rim of the Circumference
   1×1½ Aluminum Rounds Cut so as to Support the 8 Inches Disc
Step 1—The Round is Cut from 1½ to 1 Inch
Step 2—One Side of the Pieces is Perforated at 23/32×½ Inches Depth, and the Other Side is Perforated at 5/32×½ Inches Depth.
Step 3—A Countersink is Made in Both Bores
Step 4—A Chamfer is Made at Both Sides of the Rim of the Circumference
Step 5—A 3/16 and 3/18 Screw Thread is Made at Each Bore ⅜×4 Inches Cut in Aluminum Screws so as to Joint Divider Discs
Step 1—The Round is Cut from ⅜ to 4 Inches Length
Step 2—A 3/18 Screw Thread is Made at Both Sides

### Heat Sink Assembly

Step 1—The ⅜×4 Inches Screws are Placed in the 1×1½ and 1×3 Rounds
Step 2—Dissipator Grease is Provided at Each Joint Between the Discs and Dividers Until Completing 7 Discs Per Each Divider, then they are Tightened with a ⅜ Nut.
Step 3—The 8 Inches Discs is Placed at the 1 Inch Rounds at the Side of the 3/16 Screw Threads with 3/16 Conical Head Screws
   Although the above described exemplary embodiment is used to produce a heat sink, with the knowledges herein, heat sinks can be made with a higher or lower number of discs, with a greater or lesser size of dividers, or a larger or smaller discs diameter, the above is useful for producing endless heat sinks which would include specific dissipation features as required by the manufacturer, the most remarkable fact is that in this case there is no need of making a design, making a mold and extrude and cast the aluminum so as to produce the heat sinks.

The currently known machinery may be used for the manufacture, however, a machine which performs all of the above cited steps with no need of human intervention may be produced, nevertheless, it is necessary to note that due to the method requirements, the accurateness is a very important issue so a human would not be able to achieve it, thus, the high accurateness machines are needed.

Although the present invention has been shown and described in various details, those skilled in the art will know that variations may be made to the above exemplary embodiment which are within the scope of the present invention, as defined by the following claims.

1. A method for producing a heat sink comprising:
cutting an aluminum sheet, die cutting it so as to obtain discs and bend the discs sections so as to obtain fins in the discs;
boring the discs so as to create bores;
cutting an aluminum sheet, die cutting and boring it so as to create a primary dissipation disc, create threads in the bores;
die cutting an aluminum solepiece of the desired diameter so as to obtain round dividers, the center of each divider is perforated, a countersink is made in the bores;
cutting an aluminum solepiece of the desired diameter so as to obtain aluminum rounds, the pieces are perforated at a preset depth and at a preset diameter and a countersink is made in both sides bores;
assembling the sink by means of screws, and alternating dividers providing dissipator grease in each joint between the discs and the dividers, the primary dissipation disc is placed in a central aluminum round and side aluminum rounds by means of conical head screws.

2. The method for producing a heat sink of claim 1, wherein the step of cutting the aluminum sheet is performed in 14 gauge sheets in squared spans.

3. The method for producing a heat sink of claim 1, wherein the step of perforating the discs is made with four bores and a central bore wherein the bores are cross-shaped.

4. The method for producing a heat sink of claim 1, wherein the step of perforating the disc further comprises making guide bores.

5. The method for producing a heat sink of claim 1, wherein in the step of perforating the primary dissipation discs five countersunk bores are produced, perimeter bores are perforated and eight bores off-centered from the center of the disc are made, wherein the eight bores are for fixing LED lamps.

6. The method for producing a heat sink of claim 1, wherein in the step of die cutting, side aluminum dividers and central aluminum dividers are produced.

7. The method for producing a heat sink of claim 1, wherein the step of die cutting an aluminum solepiece of the desired diameter for obtaining round dividers further comprises making a chamfer at both sides of the rims of the circumference of each divider.

8. The method for producing a heat sink of claim 1, wherein in the step of die cutting an aluminum solepiece of the desired diameter for obtaining round dividers, central aluminum rounds and side aluminum rounds are produced.

9. The method for producing a heat sink of claim 1, wherein the step of cutting an aluminum solepiece of the desired diameter for obtaining aluminum rounds further comprises making a chamfer at both sides and making a screw thread of each bore depending on the preset measure.

10. A heat sink comprising:
at least two disks,
a primary dissipation disc;
at least one set of four side aluminum dividers and a central aluminum divider;
a set of central aluminum rounds and four side aluminum rounds;
wherein the at least two discs are attached to the set of four side aluminum dividers and a central aluminum divider by means of screws, nuts and washers, the set of four side aluminum dividers and a central aluminum divider amidst the at least two discs and the primary dissipation disc is placed in a central aluminum round and four side aluminum rounds by means of conical head screws to the set of at least two discs and the set of four side aluminum separators and a central aluminum separator.
